(19) United States
(12) Patent Application Publication
(10) Pub. No.: US 2026/0148500 A1
(43) Pub. Date: May 28, 2026

(54) SOMATIC SENSATION CONTROL DEVICE, METHOD AND PROGRAM

(71) Applicant: NTT, Inc., Tokyo (JP)

(72) Inventors: Mana Sasagawa, Musashino-shi, Tokyo (JP); Arinobu NIIJIMA, Musashino-shi, Tokyo (JP); Naoki HAGIYAMA, Musashino-shi, Tokyo (JP); Shunichi SEKO, Musashino-shi, Tokyo (JP); Ryuji Yamamoto, Musashino-shi, Tokyo (JP)

(21) Appl. No.: 19/114,721

(22) PCT Filed: Oct. 18, 2022
(86) PCT No.: PCT/JP2022/038760

§ 371 Date: Mar. 24, 2025

(51) Int. Cl. G06T 19/00; G02B 27/01; H04N 7/15

(52) U.S. Cl. CPC G06T 19/00; G02B 27/017; H04N 7/157

(57) ABSTRACT

In one aspect of the present invention, when information indicating a virtual reality space including an avatar corresponding to a user is displayed on a head-mounted display worn by the user, mind and body information indicating a state of mind and body of the user is acquired, and effect information for causing the user to perceive or have an illusion of the state of the mind and body is generated on the basis of the acquired mind and body information. The effect information is then reflected on the avatar included in the information indicating the virtual reality space, and information indicating the virtual reality space including the avatar on which the effect information is reflected is output to the head-mounted display.

### TECHNICAL FIELD

One aspect of the present invention relates to a somatosensory control device, method, and program using, for example, virtual reality (VR) technology.

### BACKGROUND ART

In recent years, various services using VR technology have been proposed. For example, NPL 1 describes a technology related to a service for sport training using VR technology. This service recreates sports conditions in a virtual space on the basis of measurement data acquired in sports scenes, and allows users to experience the sports conditions through a head-mounted display (HMD) to help them in their own training. Another service using VR technology has been proposed, which involves communication such as an online conference using avatars on the metaverse.

### CITATION LIST

### Non Patent Literature

[NPL 1] Dan Mikami et al., “A Trial on Sport Training using VR Technology,” Journal of the Imaging Society of Japan, Vol. 58, No. 3, p. 316-323 (2019)

### SUMMARY OF INVENTION

### Technical Problem

However, in a case where a user experiences a VR space by wearing an HMD, the user cannot visually recognize the real space, making it difficult for the user to recognize his or her own somatic sensations in the real space. Therefore, methods have been devised that allow a user immersed in a VR space to recognize his or her own somatic sensations in the real space, for example by capturing an image of the user's state in the real space with a camera and displaying the video data together in the VR space, or by displaying text data describing the user's situation in the VR space.

However, this method inhibits the sense of immersion that is characteristic of the experience of a VR space using an HMD, and may lead to a decrease in the user's concentration and motivation in training, conferences, etc. that use VR technology.

The present invention has been made in light of the above-mentioned circumstances, and aims to provide a technology that enables a user to recognize his or her own somatic sensations in a real space without losing the sense of immersion in a virtual reality space.

### Solution to Problem

In order to solve the above problems, according to one aspect of the present invention, there is provided a somatosensory control device or method in which, when information indicating a virtual reality space including an avatar corresponding to a user is displayed on a head-mounted display worn by the user, mind and body information indicating a state of mind and body of the user is acquired, and effect information for causing the user to perceive or have an illusion of the state of the mind and body is generated on the basis of the acquired mind and body information. The effect information is then reflected on the avatar included in the information indicating the virtual reality space, and information indicating the virtual reality space including the avatar on which the effect information is reflected is output to the head-mounted display.

According to one aspect of the present invention, for example, effect information indicating the user's own mind and body state at that time is reflected on an avatar corresponding to the user included in information indicating a virtual reality space. This allows the user to perceive or have an illusion of his or her own state in a real space from the appearance of his or her avatar while viewing information indicating the virtual reality space on the HMD. As a result, the user can recognize his or her own somatic sensations without losing the sense of immersion in the virtual reality space.

### Advantageous Effects of Invention

That is, according to one aspect of the present invention, a technology can be provided that enables a user to recognize his or her own somatic sensations in a real space without losing the sense of immersion in the virtual reality space.

### BRIEF DESCRIPTION OF DRAWINGS

FIG. 1 is a diagram illustrating an example of an online conference system equipped with a somatosensory control device according to a first embodiment of the present invention.

FIG. 2 is a block diagram illustrating an example of a hardware configuration of the somatosensory control device according to the first embodiment of the present invention.

FIG. 3 is a block diagram illustrating an example of a software configuration of the somatosensory control device according to the first embodiment of the present invention.

FIG. 4 is a flowchart showing an example of a processing procedure and processing content of somatosensory control processing executed by a control unit of the somatosensory control device illustrated in FIG. 3.

FIG. 5 is a diagram showing an example of VR effect information used to describe a first example of the first embodiment.

FIG. 6 is a diagram showing an example of VR effect information used to describe a second example of the first embodiment.

FIG. 7 is a diagram showing an example of VR effect information used to describe a third example of the first embodiment.

### DESCRIPTION OF EMBODIMENTS

Embodiments of the present invention will be described below with reference to the drawings.

### Principle

An embodiment of the present invention focuses on the “Proteus effect,” in which the facial expressions and behavior of a character such as an avatar representing a user's alter-ego affect the user's behavioral characteristics and extroversion in an online conference system that uses VR technology.

The “Proteus effect” refers to the phenomenon in which, for example, in online games using VR technology, a person controlling an avatar character with a strong physique experiences changes in the game, such as acting more boldly and negotiating more aggressively. This change in behavior can extend beyond just online behavior to users' real-life behavior. The “Proteus effect” is reported in detail, for example, in the following reference documents.
Reference Document 1: Nick Yee, & Jeremy Bailenson, “The Proteus effect: The effect of transformed self-representation on behavior.” Human communication research, 33(3), 271-290. 2019.
Reference Document 2: Konstantina Kilteni, Ilias Bergstrom and Mel SlaterBergstrom, “Drumming in immersive virtual reality: the body shapes the way we play.” IEEE transactions on visualization and computer graphics, 19(4), 597-605. 2013.

An embodiment of the present invention focuses on the above-mentioned “Proteus effect” and measures the user's mind and body state using sensors when, for example, an online conference situation is displayed as VR space data on a head-mounted display (HMD) worn by the user. Then, on the basis of measurement information thereof, VR effect information for allowing the user to perceive or have an illusion of the user's mind and body state is generated, and the generated VR effect information is reflected on the user's avatar in the VR space data. Then, the VR space data including the avatar on which this VR effect information is reflected is displayed on the HMD.

According to the embodiment of the present invention, the appearance of an avatar included in VR space data displayed on an HMD makes it possible for a user to perceive or have an illusion of his or her own mind and body state in a real space. In other words, the user can recognize his or her own somatic sensations in the real space without losing the sense of immersion in the VR space.

### First Embodiment

### Configuration Example

### (1) System

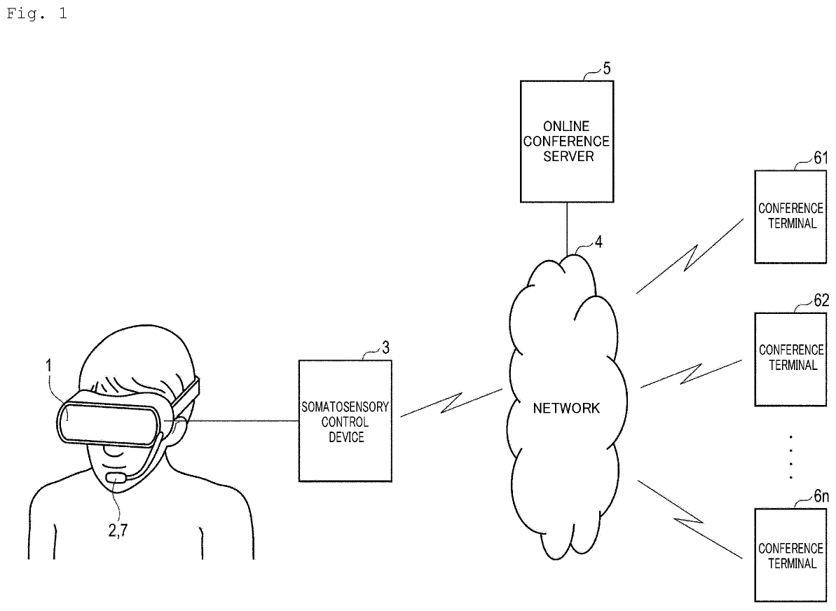

FIG. 1 is a diagram illustrating an example of a VR online conference system equipped with a somatosensory control device according to a first embodiment of the present invention.

In the system according to the first embodiment, a user uses a headset-type HMD 1 equipped with a microphone 2 to hold an online conference in a VR space with other participants' conference terminals 61 to 6n via an online conference server 5 disposed on a network 4, and a somatosensory control device 3 is connected to the HMD 1.

The microphone 2 is provided with a breath sensor 7 for detecting the alcohol concentration contained in the user's breath. The breath sensor transmits a detection signal of the breath alcohol concentration to the somatosensory control device 3 via the HMD 1.

As a sensor for detecting breath alcohol concentration, for example, the one described on the following website can be used. <URL: https://www.switch-science.com/catalog/6652/>.

The online conference server 5 enables online conference communication using a VR space between terminals of a plurality of conference participants, including the user. The terminals used by the conference participants are general-purpose personal computers.

The network 4 includes, for example, a wide area network centered on the Internet and an access network for accessing the wide area network. As the access network, for example, a public communication network using a wired or wireless connection, a local area network (LAN) using a wired or wireless connection, or a cable television (CATV) network is used. The network 4 may also include broadcast media using terrestrial or satellite broadcasting.

### (2) Somatosensory Control Device 3

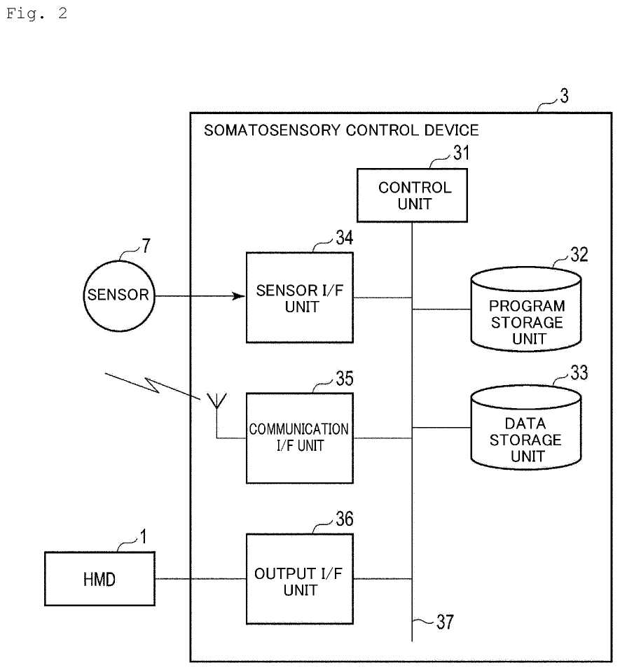

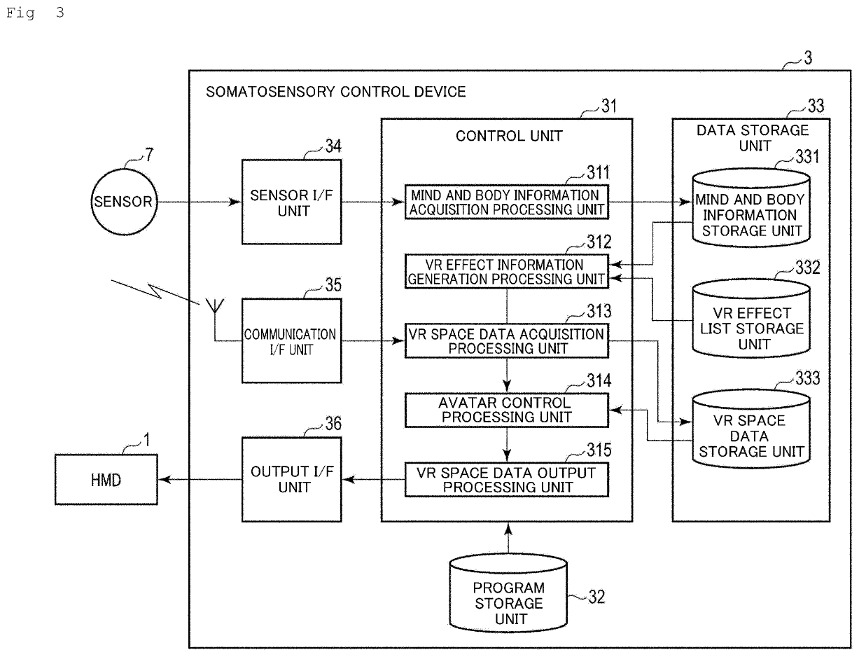

FIGS. 2 and 3 are block diagrams respectively illustrating examples of hardware and software configurations of the somatosensory control device 3 according to the first embodiment of the present invention.

The somatosensory control device 3 is, for example, a personal computer, and includes a control unit 31 that uses a hardware processor such as a central processing unit (CPU). This control unit 31 is connected via a bus 37 to a storage unit having a program storage unit 32 and a data storage unit 33, a sensor interface (hereinafter, interface will be abbreviated to I/F) unit 34, a communication I/F unit 35, and an input/output I/F unit 36.

In addition, as the somatosensory control device 3, for example, a smartphone or a tablet terminal other than a personal computer may be used. The somatosensory control device 3 may also be used as a terminal that the user uses for online conference communication, and furthermore, its function may be built into the HMD 1.

The sensor I/F unit 34 receives the breath alcohol concentration detection signal output from the breath sensor 7 and converts it into digital data. The communication I/F unit 35 transmits and receives VR space data to and from the online conference server 5 via the network 4. The input/output I/F unit 36 receives transmission data including the user's video and audio output from the HMD 1, and transmits VR space data output from the control unit 31 to the HMD 1.

In addition, the sensor I/F unit 34 may be integrated into the input/output I/F unit 36, and the sensor I/F unit 34 and the input/output I/F unit 36 may be provided with a wireless interface function that employs a low-power wireless data communication standard such as Bluetooth (registered trademark). By using the wireless interface function, signals can be transmitted and received between the somatosensory control device 3 and the HMD 1 in a cordless manner.

The program storage unit 32 is configured, for example, by combining a non-volatile memory such as a solid state drive (SSD) that can be written to and read from at any time and a non-volatile memory such as a read only memory (ROM) serving as storage mediums, and stores application programs necessary for executing various controls according to the first embodiment in addition to middleware such as an operating system (OS). Hereinafter, the OS and each application program will be collectively referred to as programs.

The data storage unit 33 is, for example, a combination of a non-volatile memory, such as an SSD on which writing and reading can be performed at any time, and a volatile memory, such as a random access memory (RAN), as a storage medium, and its storage area includes a mind and body information storage unit 331, a VR effect list storage unit 332, and a VR space data storage unit 333 as main storage units necessary for implementing the first embodiment of the present invention.

The mind and body information storage unit 331 is used to temporarily store detection data of the breath alcohol concentration received from the breath sensor 7. The VR effect list storage unit 332 stores, in advance, VR effect information for changing an avatar in the VR space in association with a plurality of breath alcohol concentration values. The VR space data storage unit 333 is used to temporarily store the VR space data transmitted from the online conference server 5 for avatar control processing.

The control unit 31 includes, as processing functions necessary for implementing the first embodiment of the present invention, a mind and body information acquisition processing unit 311, a VR effect information generation processing unit 312, a VR space data acquisition processing unit 313, an avatar control processing unit 314, and a VR space data output processing unit 315. These processing units 311 to 315 are all implemented by causing the hardware processor of the control unit 31 to execute an application program stored in the program storage unit 32.

Incidentally, some or all of the processing units 311 to 315 may be implemented using hardware such as a large scale integration (LSI) or an application specific integrated circuit (ASIC).

The mind and body information acquisition processing unit 311 receives breath alcohol concentration detection data of a user participating in an online conference from the breath sensor 7, and temporarily stores the received breath alcohol concentration detection data in the mind and body information storage unit 331 as information indicating the user's mind and body state.

The VR effect information generation processing unit 312 searches the VR effect list storage unit 332 for corresponding VR effect information on the basis of the detection data of the breath alcohol concentration stored in the mind and body information storage unit 331.

The VR space data acquisition processing unit 313 receives VR space data representing the conference space transmitted from the online conference server 5 via the communication I/F unit 35, and temporarily stores the received VR space data in the VR space data storage unit 333.

The avatar control processing unit 314 reads the VR space data from the VR space data storage unit 333, and reflects the VR effect information generated by the VR effect information generation processing unit 312 on the user's avatar included in the read VR space data. An example of the process of reflecting VR effect information on an avatar will be described in the operation example.

The VR space data output processing unit 315 outputs the VR space data including the avatar on which the VR effect information is reflected by the avatar control processing unit 314 from the input/output I/F unit 36 to the HMD 1 to display the VR space data.

### Operation Example

Next, an operation example of the somatosensory control device 3 configured as above will be described.

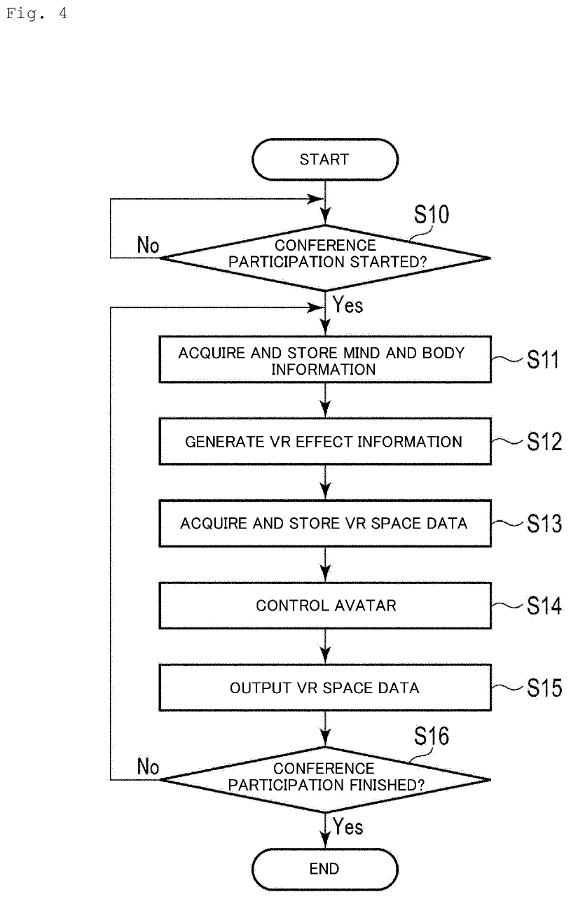

FIG. 4 is a flowchart showing an example of a processing procedure and processing content of somatosensory control processing executed by the control unit 31 of the somatosensory control device 3.

### (1) Acquisition of Mind and Body Information

The control unit 31 of the somatosensory control device 3 monitors whether or not the user has participated in the online conference in step S10.

In this state, when the user participates in a conference, the control unit 31 of the somatosensory control device 3 first receives, in step S11, detection data of the user's breath alcohol concentration detected by the breath sensor 7 via the sensor I/F unit 34 under the control of the mind and body information acquisition processing unit 311, and stores the received detection data in the mind and body information storage unit 331 as information indicating the user's mind and body state.

The detection data of the breath alcohol concentration may be acquired at all times, or may be acquired periodically at a predetermined time interval for a certain period of time. The acquired detection data may be sampled at a predetermined sampling interval and stored.

### (2) Generation of VR Effect Information

Next, in step S12, the control unit 31 of the somatosensory control device 3 reads the detection data of the breath alcohol concentration from the mind and body information storage unit 331 at regular intervals under the control of the VR effect information generation processing unit 312. Then, the VR effect list storage unit 332 is searched for VR effect information corresponding to the read detection data of the breath alcohol concentration. Then, the found VR effect information is passed to the avatar control processing unit 314.

In addition, in a case where the user has drunk alcohol before participating in the conference, it is estimated that the breath alcohol concentration will not increase any further. Therefore, the detection data of the breath alcohol concentration may be read only once immediately after starting to participate in the conference. However, in case the user continues to drink alcohol during the conference, it is desirable to continue to read the detection data of the breath alcohol concentration periodically thereafter and update the VR effect information.

### (3) Acquisition of VR Space Information

While the user is participating in the conference, the control unit 31 of the somatosensory control device 3 receives VR space data transmitted from the online conference server 5 via the communication I/F unit 35 in step S13 under the control of the VR space data acquisition processing unit 313, and temporarily stores the received VR space data in the VR space data storage unit 333.

### (4) Avatar Control

Next, in step S14, the control unit 31 of the somatosensory control device 3 reads the VR space data from the VR space data storage unit 333, and recognizes the user's avatar included in the read VR space data, under the control of the avatar control processing unit 314. Then, the avatar control processing unit 314 performs a process of reflecting the VR effect information generated by the VR effect information generation processing unit 312 on the recognized avatar.

Hereinafter, several examples showing an example of the reflection process will be described.

### First Example

In a first example, the VR effect is reflected in the arm movements of an avatar.

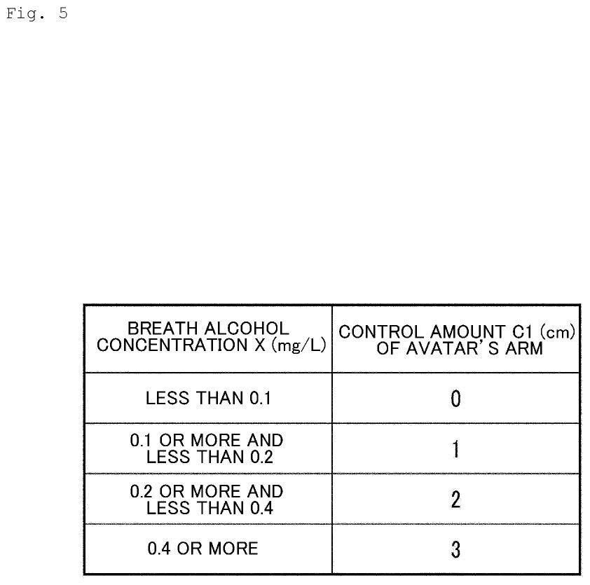

FIG. 5 shows an example of a VR effect list used in the first example. That is, the VR effect list storage unit 332 stores a control amount C1 of the avatar's arm in association with a plurality of preset ranges of breath alcohol concentration values. This control amount C1 is used to give the avatar a trembling of the arms as a VR effect, and defines, for example, the amplitude of arm trembling per unit time.

The avatar control processing unit 314 performs image conversion to vibrate the image showing the arm part of the avatar in accordance with the control amount C1. For example, if the breath alcohol concentration [mg/L] is less than 0.1, the arm is not shaken, but if the breath alcohol concentration [mg/L] is 0.2 or greater and less than 0.4, the arm is vibrated at 2 cm per second. Similarly, if the breath alcohol concentration [mg/L] is 0.4 or greater, the arm is vibrated even more rapidly at 3 cm per second.

Then, the avatar control processing unit 314 passes the VR space data including the avatar whose arms have been given trembling as described above to the VR space data output processing unit 315.

### Second Example

In a second example, the VR effect is reflected in the quality of the avatar's voice.

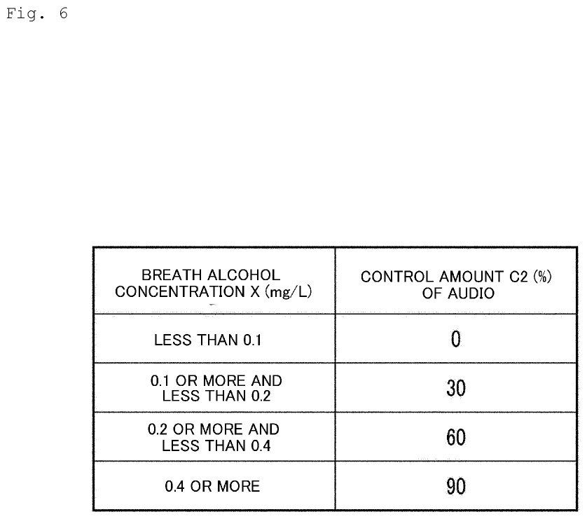

FIG. 6 shows an example of a VR effect list used in the second example. That is, the VR effect list storage unit 332 stores a control amount C2 for changing the quality of the avatar's voice in association with a plurality of preset breath alcohol concentration values. This control amount C2 is used to blur the voice of the avatar as a VR effect, and is indicated by control information of a filter characteristic that changes the frequency characteristic of the voice, for example.

The avatar control processing unit 314 changes the frequency characteristics of the avatar's voice by filtering in accordance with the control amount C2, thereby blurring the voice. For example, if the breath alcohol concentration [mg/L] is less than 0.1, the voice is not blurred, but if the breath alcohol concentration [mg/L] is 0.2 or greater and less than 0.4, the frequency characteristics of the voice are changed by 60%. Similarly, if the breath alcohol concentration [mg/L] is 0.4 or greater, the frequency characteristics of the voice are changed by 90%.

Then, the avatar control processing unit 314 passes the VR space data including the avatar whose voice quality has been converted as described above to the VR space data output processing unit 315.

### Third Example

In a third example, the VR effect is reflected in the image around the avatar.

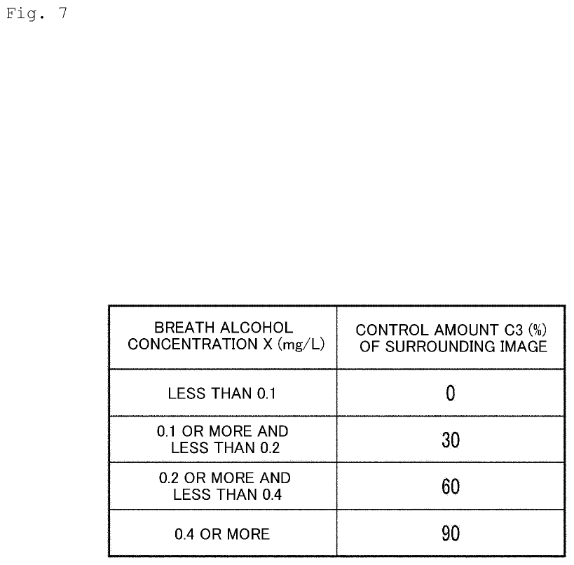

FIG. 7 shows an example of a VR effect list used in the third example. That is, the VR effect list storage unit 332 stores a control amount C3 for changing the surrounding image of the avatar in association with a plurality of preset breath alcohol concentration values. This control amount C3 is used to shake or rotate objects present around the avatar as a VR effect, and is indicated by image control information for shaking or rotating the display position of the surrounding image, for example.

The avatar control processing unit 314 performs image processing to impart shaking or distortion to objects present around the avatar in the VR space data in accordance with the control amount C3, thereby making it appear as if the scenery seen by the avatar is shaking or spinning due to intoxication. For example, if the breath alcohol concentration [mg/L] is less than 0.1, the surrounding image is not changed, but if the breath alcohol concentration [mg/L] is 0.2 or greater and less than 0.4, the display position of the surrounding image is changed by 60%. Similarly, if the breath alcohol concentration [mg/L] is 0.4 or greater, the display position of the surrounding image is changed by 90%.

Then, the avatar control processing unit 314 passes the VR space data in which the shaking or rotation has been applied to the objects around the avatar as described above to the VR space data output processing unit 315.

### (5) Output of VR Space Data

Next, in step S15, the control unit 31 of the somatosensory control device 3 receives VR space data in which the user's avatar is controlled from the avatar control processing unit 314 under the control of the VR space data output processing unit 315, and outputs the received VR space data from the input/output I/F unit 36 to the HMD 1.

As a result, the HMD 1 displays VR space data including an avatar on which a VR effect that represents an intoxicated state is reflected according to the breath alcohol concentration of the user. Therefore, while the user is immersed in the VR space displayed on the HMD 1, the user can perceive his/her own state in the real space from the appearance of his/her avatar existing in the VR space data.

Finally, in step S16, the control unit 31 of the somatosensory control device 3 determines whether or not the user has left the conference. In a case where the user wishes to continue participating in the conference, the process returns to step S11 to repeatedly execute a series of processes from acquisition of the mind and body information to reflection of the VR effect information on the avatar, and display of the VR space data after reflecting the information. On the other hand, when the conference ends or the user leaves the conference halfway, the process ends and the standby state is restored.

### Operations and Effects

As described above, in the first embodiment, detection data of the breath alcohol concentration of a user participating in an online conference using a VR space is acquired from the breath sensor 7, and VR effect information corresponding to the acquired breath alcohol concentration is generated on the basis of the VR effect list storage unit 332. Then, the VR effect information is reflected on the user's avatar included in the VR space data received from the online conference server 5, and the VR space data including the avatar after this reflection process is output to the HMD 1 for display.

Therefore, even when the user is immersed in the VR space displayed on the HMD 1, the user can perceive his/her own state of intoxication in the real space from the appearance of his/her avatar in the VR space data. In other words, the user can recognize his or her own somatic sensations in the real space without losing the sense of immersion in the VR space.

In the above description, “trembling arms,” “blurring voice,” and “shaking or rotating surrounding objects” are selectively used as symptoms of intoxication. However, since the type and severity of intoxication symptoms vary depending on users, it is advisable to ask the user about their intoxication symptoms in advance and reflect the results in the system. Other symptoms of intoxication may include “change in facial color,” “relaxation of the face,” “facial expression of drowsiness,” etc.

As another example of the state of intoxication, VR effect information indicating a walking style such as a staggering gait may be generated and reflected on the avatar, thereby allowing the user to perceive the degree of the state of intoxication.

### Second Embodiment

In the first embodiment, the case where the user's state of intoxication is reflected on the avatar has been described as an example. In contrast to this, a second embodiment of the present invention is configured to reflect the user's degree of fatigue or alertness on an avatar.

Since the functions and processing procedures of the somatosensory control device 3 are basically the same as those illustrated in FIGS. 3 and 4, the second embodiment will also be described with reference with FIGS. 3 and 4.

The user's degree of fatigue or alertness can be estimated from biological information obtained by a biological sensor. For example, the degree of fatigue can be estimated from the heart rate and facial color using a heart rate sensor or a face image captured by a camera.

In addition, the degree of alertness is obtained by disposing two types of sensors, a photoplethysmogram sensor and a thermopile, in the HMD 1, and measuring the photoplethysmogram and respiratory waveform using these sensors. To measure respiration, for example, a thermopile is disposed to measure the temperature difference between the inhaled and exhaled air. The photoplethysmogram is measured using a photoplethysmogram sensor, and is obtained by calculating the peak interval RRI of the pulse wave. The degree of alertness can be estimated by evaluating patterns of heart rate variability.

The method for measuring the degree of alertness is introduced, for example, at the following website. <URL: https://www.itmedia.co.jp/news/articles/2001/24/news030.html>.

The control unit 31 of the somatosensory control device 3 acquires the biological information output from the biological sensor under the control of the mind and body information acquisition processing unit 311 in step S11. Then, in step S12, under the control of the VR effect information generation processing unit 312, the degree of fatigue or alertness is estimated from the acquired biological information, and corresponding VR effect information is read out from the VR effect list storage unit 332 on the basis of the estimated degree of fatigue or alertness.

For example, the VR effect list storage unit 332 registers, in association with an estimated value (%) of the degree of fatigue or alertness, an image control amount for changing the image of the avatar's face or body, an audio control amount, or a control amount of the display range or display state of surrounding objects to represent a change in the field of view. Then, on the basis of the estimated value of the degree of fatigue or alertness, the VR effect list storage unit 332 reads out the corresponding image control amount, audio control amount, or control amount of the display range or display state of surrounding objects from the VR effect list storage unit 332, and uses the read-out control amount as VR effect information.

Next, in step S14, the control unit 31 of the somatosensory control device 3 performs processing for reflecting the above-mentioned VR effect information on the avatar included in the VR space data acquired by the VR space data acquisition processing unit 313 under the control of the avatar control processing unit 314. Then, in step S15, the VR space data in which the VR effect information is reflected is output from the input/output I/F unit 36 to the HMD 1 under the control of the VR space data output processing unit 315.

Thus, the HMD 1 displays VR space data in which the user's degree of fatigue or alertness is reflected on the avatar, and while immersed in the VR space, the user can perceive his or her own degree of fatigue or alertness in the real space through the avatar in the VR space.

### Third Embodiment

In the above first embodiment, the case where the user's state of intoxication is reflected on the avatar has been described. In contrast, a third embodiment of the present invention acquires a measurement value of the amount of a non-alcoholic beverage consumed by a user in a case where the user consumes the beverage, generates VR effect information indicating the state of intoxication corresponding to the acquired amount consumed, and reflects this information on an avatar, thereby giving the user an illusion of an intoxicated state.

Also in the third embodiment, the functions and processing procedures of the somatosensory control device 3 are basically the same as those illustrated in FIGS. 3 and 4. Therefore, the description will be given with reference with FIGS. 3 and 4.

The amount of non-alcoholic beverage consumed by the user can be obtained, for example, by providing a weight sensor on the cup itself, or on the coaster or mat, and acquiring a weight measurement value output from this weight sensor as information indicating the amount consumed.

The control unit 31 of the somatosensory control device 3 acquires the measurement data output from the weight sensor under the control of the mind and body information acquisition processing unit 311 in step S11. Then, in step S12, under the control of the VR effect information generation processing unit 312, the amount of non-alcoholic beverage consumed by the user is calculated from the acquired measurement data, and VR effect information for giving the user an illusion of an intoxicated state is read out from the VR effect list storage unit 332 on the basis of the calculated amount of non-alcoholic beverage consumed.

For example, the VR effect list storage unit 332 registers, in association with the amount of alcohol consumed in mL (or mg), an image control amount for changing the avatar's face or body to an intoxicated state, an audio control amount, or a control amount for imparting shaking or rotation to surrounding objects. Then, on the basis of the measurement value of the non-alcoholic beverage, the VR effect information generation processing unit 312 reads out the corresponding image control amount, audio control amount, or control amount of the display state of surrounding objects from the VR effect list storage unit 332, and uses the read-out control amount as VR effect information.

Next, in step S14, the control unit 31 of the somatosensory control device 3 performs processing for reflecting the above-mentioned VR effect information on the avatar included in the VR space data acquired by the VR space data acquisition processing unit 313 under the control of the avatar control processing unit 314. Then, in step S15, the VR space data in which the VR effect information is reflected is output from the input/output I/F unit 36 to the HMD 1 under the control of the VR space data output processing unit 315.

Thus, the HMD 1 displays VR space data in which the state of intoxication corresponding to the amount of non-alcoholic beverage the user has consumed is reflected on the avatar, making it possible to give the user an illusion of an intoxicated state using the avatar in the VR space.

### OTHER EMBODIMENTS

(1) In the second embodiment, the case where the user is made to perceive the degree of fatigue or alertness using an avatar has been described as an example. However, in a case where the degree of fatigue or alertness is less than a preset threshold value, VR effect information for invigorating the user may be generated and reflected on the avatar, and VR space data including this avatar may be displayed on the HMD 1. In this way, it is possible to energize and motivate the user through the Proteus effect using the avatar.
(2) The body temperature of a user immersed in a VR space may be measured, for example, by a temperature sensor provided in the HMD 1, and the user may be made to perceive the degree of fever of the user using an avatar on the basis of the measurement value. In addition, any type of mind and body state of the user to be acquired and any control content for reflecting the VR effect on the avatar may be used.
(3) In addition, the functional configuration of the somatosensory control device, its processing procedures and processing contents, the types and contents of the VR effect information, and the like can be modified in various ways without departing from the gist of the present invention.

Although the embodiments of the present invention have been described in detail above, the above description is merely illustrative of the present invention in every respect. It goes without saying that various modifications and variations can be made without departing from the scope of the present invention. In other words, a specific configuration according to the embodiment may be appropriately employed in implementing the present invention.

The present invention is not limited to the embodiment as it is but can be embodied by modifying components in the practical phase without departing from the gist thereof. Further, various inventions can be formed by appropriate combinations of the plurality of components disclosed in the above embodiments. For example, some components of all the components shown in the embodiment may be omitted. Further, constituent elements in different embodiments may be appropriately combined.

### REFERENCE SIGNS LIST

| | |
|---|---|
| 1 | Head-mounted display (HMD) |
| 2 | Microphone |
| 3 | Somatosensory control device |
| 4 | Network |
| 5 | Online conference server |
| 61 to 6n | Conference terminal of participant |
| 7 | Breath sensor |
| 31 | Control unit |
| 32 | Program storage unit |
| 33 | Data storage unit |
| 34 | Sensor I/F unit |
| 35 | Communication I/F unit |
| 36 | Input/output I/F unit |
| 37 | Bus |
| 311 | Mind and body information acquisition processing unit |
| 312 | VR effect information generation processing unit |
| 313 | VR space data acquisition processing unit |
| 314 | Avatar control processing unit |
| 315 | VR space data output processing unit |
| 331 | Mind and body information storage unit |
| 332 | VR effect list storage unit |
| 333 | VR space data storage unit |

1. A somatosensory control device connected to a head-mounted display that is worn by a user and displays information indicating a virtual reality space including an avatar corresponding to the user, the somatosensory control device comprising:
a first processing unit, including one or more processors, configured to acquire mind and body information indicating a state of mind and body of the user;
a second processing unit, including one or more processors, configured to generate effect information for causing the user to perceive or have an illusion of the state of the mind and body on the basis of the mind and body information;
a third processing unit, including one or more processors, configured to reflect the effect information on the avatar included in the information indicating the virtual reality space; and
a fourth processing unit, including one or more processors, configured to output information indicating the virtual reality space including the avatar on which the effect information is reflected to the head-mounted display.

2. The somatosensory control device according to claim 1,
wherein the first processing unit is configured to acquire, as the mind and body information, measurement information of an alcohol concentration originating from the user, and
the second processing unit is configured to generate, as the effect information, information for causing the user to perceive or have an illusion of an influence of the alcohol concentration on the mind and body.

3. The somatosensory control device according to claim 1,
wherein the first processing unit is configured to acquire, as the mind and body information, information indicating a degree of fatigue of the user, and
the second processing unit is configured to generate, as the effect information, information for causing the user to perceive or have an illusion of the degree of fatigue of the user.

4. The somatosensory control device according to claim 1,
wherein the first processing unit is configured to acquire, as the mind and body information, information indicating a degree of alertness of the user, and
the second processing unit is configured to generate, as the effect information, information for causing the user to perceive or have an illusion of the degree of alertness of the user.

5. The somatosensory control device according to claim 1,
wherein the second processing unit is configured to generate, as the effect information, at least one of image control information for changing a body movement of the avatar, audio control information for changing a voice with which the avatar speaks, and display control information for changing a display state of the avatar and a surrounding image of the avatar, and
the third processing unit is configured to change at least one of a body movement, a voice, and a surrounding image of the avatar included in the information indicating the virtual reality space on the basis of at least one of the image control information, the audio control information, and the display control information.

6. A somatosensory control method executed by an information processing device connected to a head-mounted display that is worn by a user and displays information indicating a virtual reality space including an avatar corresponding to the user, the somatosensory control method comprising:
acquiring mind and body information indicating a state of mind and body of the user;
generating effect information for causing the user to perceive or have an illusion of the state of the mind and body on the basis of the mind and body information;
reflecting the effect information on the avatar included in the information indicating the virtual reality space; and
outputting information indicating the virtual reality space including the avatar on which the effect information is reflected to the head-mounted display.

7. A non-transitory computer-readable storage medium storing a program causing a processor included in a somatosensory control device connected to a head-mounted display that is worn by a user and displays information indicating a virtual reality space including an avatar corresponding to the user to perform operations comprising:
acquiring mind and body information indicating a state of mind and body of the user;
generating effect information for causing the user to perceive or have an illusion of the state of the mind and body on the basis of the mind and body information;
reflecting the effect information on the avatar included in the information indicating the virtual reality space; and
outputting information indicating the virtual reality space including the avatar on which the effect information is reflected to the head-mounted display.

8. The somatosensory control method according to claim 6, further comprising:
acquiring, as the mind and body information, measurement information of an alcohol
generating, as the effect information, information for causing the user to perceive or have an illusion of an influence of the alcohol concentration on the mind and body.

9. The somatosensory control method according to claim 6, further comprising:
acquiring, as the mind and body information, information indicating a degree of fatigue of the user, and
generating, as the effect information, information for causing the user to perceive or have an illusion of the degree of fatigue of the user.

10. The somatosensory control method according to claim 6, further comprising:
acquiring, as the mind and body information, information indicating a degree of alertness of the user, and
generating, as the effect information, information for causing the user to perceive or have an illusion of the degree of alertness of the user.

11. The somatosensory control method according to claim 6, further comprising:
generating, as the effect information, at least one of image control information for changing a body movement of the avatar, audio control information for changing a voice with which the avatar speaks, and display control information for changing a display state of the avatar and a surrounding image of the avatar, and
changing at least one of a body movement, a voice, and a surrounding image of the avatar included in the information indicating the virtual reality space on the basis of at least one of the image control information, the audio control information, and the display control information.

12. The non-transitory computer-readable storage medium according to claim 7, wherein the operations further comprise:
acquiring, as the mind and body information, measurement information of an alcohol
generating, as the effect information, information for causing the user to perceive or have an illusion of an influence of the alcohol concentration on the mind and body.

13. The non-transitory computer-readable storage medium according to claim 7, wherein the operations further comprise:
acquiring, as the mind and body information, information indicating a degree of fatigue of the user, and
generating, as the effect information, information for causing the user to perceive or have an illusion of the degree of fatigue of the user.

14. The non-transitory computer-readable storage medium according to claim 7, wherein the operations further comprise:
acquiring, as the mind and body information, information indicating a degree of alertness of the user, and
generating, as the effect information, information for causing the user to perceive or have an illusion of the degree of alertness of the user.

15. The non-transitory computer-readable storage medium according to claim 7, wherein the operations further comprise:
generating, as the effect information, at least one of image control information for changing a body movement of the avatar, audio control information for changing a voice with which the avatar speaks, and display control information for changing a display state of the avatar and a surrounding image of the avatar, and
changing at least one of a body movement, a voice, and a surrounding image of the avatar included in the information indicating the virtual reality space on the basis of at least one of the image control information, the audio control information, and the display control information.
